(19) United States
(12) Patent Application Publication
(10) Pub. No.: US 2022/0261816 A1
(43) Pub. Date: Aug. 18, 2022

(54) STRUCTURED COMMUNICATION SYSTEM INTEGRATING DYNAMIC DISPLAY

(71) Applicant: Wix.com Ltd., Tel Aviv (IL)

(72) Inventors: Itay GADOT, Tel Aviv (IL); Nimrod Gavish, Tel Aviv (IL); Elad Eran, Tel Aviv (IL); Lital Poria, Ramat Gan (IL)

(21) Appl. No.: 17/673,933

(22) Filed: Feb. 17, 2022

Related U.S. Application Data
(60) Provisional application No. 63/150,760, filed on Feb. 18, 2021.

(51) Int. Cl. G06Q 30/00

(52) U.S. Cl. CPC G06Q 30/016

(57) ABSTRACT

A communication system includes a processor and a unit running on the processor, the unit to create and handle a dynamic display of at least one ticket representing an incoming event for a supported system supported by the communication system, the at least one ticket further representing activities related to the incoming event and the status of multiple channels of interactivity between at least one client and at least one agent associated with the supported system, the unit further including a ticket subsystem to receive the incoming event, the activities and the multiple channels of interactivity from at least one communication channel and to create and update the at least one ticket accordingly and an inbox/feed subsystem to create and display a one-inbox feed for the at least one ticket for the at least one agent.

### CROSS REFERENCE TO RELATED APPLICATIONS

This application claims priority from U.S. provisional patent application 63/150,760, filed Feb. 18, 2021, which is incorporated herein by reference.

### FIELD OF THE INVENTION

The present invention relates to a system providing communication and support to a supported system and to handling multiple channels of interactivity in particular.

### BACKGROUND OF THE INVENTION

Customer support systems (such as help desk systems) are known in the art. In general, they allow a group of agents to support multiple customers through a system which tracks issues raised by a calling user through a ticket (also known as “trouble ticket”). Such prior art systems typically track the activities performed associated with the pertinent issue, including agent comments and notes about actions taken and interactions made. Such systems often store the tickets in an underlying database and can typically allow reassignment of tickets from one agent to another, e.g., when a work shift ends, or when a ticket is assigned to an agent having specific required expertise.

US Patent Publication No. 2014/0278646 entitled “Work Assignment Queue Elimination” published Sep. 18, 2014, describes a method for work assignment queue elimination using an ordered list of ticket assignment rules.

### SUMMARY OF THE PRESENT INVENTION

There is therefore provided, in accordance with a preferred embodiment of the present invention, a communication system and a method implemented thereon. The system includes a processor; and a unit running on the processor, the unit to create and handle a dynamic display of at least one ticket, the at least one ticket representing an incoming event for a supported system supported by the communication system, the at least one ticket further representing activities related to the incoming event and the status of multiple channels of interactivity between at least one client and at least one agent associated with the supported system. The unit includes a ticket subsystem to receive the incoming event, the activities and the multiple channels of interactivity from at least one communication channel and to create and update the at least one ticket accordingly and an inbox/feed subsystem to create and display a one-inbox feed for the at least one ticket for the at least one agent.

Moreover, in accordance with a preferred embodiment of the present invention, the communication system is integrated with the supported system.

Further, in accordance with a preferred embodiment of the present invention, the system also includes a channel transformer to adapt a user interface of the communication system to communicate with at least one client device belonging to the at least one agent.

Still further, in accordance with a preferred embodiment of the present invention, the system includes a repository storing at least ticket information and parameters, agent profiles, management data and pre-defined rules; a data gathering, recording and analysis (DGRA) subsystem to provide data gathering and analysis of gathered information for the ticket subsystem and the inbox/feed subsystem; a knowledge base (KB) creator and editor to create and edit knowledge base content for use by the ticket subsystem; a bot agent operator to integrate bot agents into the functionality of the at least one agent; and a rule engine to provide rule, artificial intelligence and machine learning support to the ticket subsystem, the inbox/feed subsystem, the DGRA subsystem, the KB creator and editor and the bot agent operator.

Additionally, in accordance with a preferred embodiment of the present invention, the ticket subsystem includes at least one of: a ticket handler to receive the incoming event, a ticket creator to create a ticket for the incoming event, a ticket updater to update the ticket for the incoming event according to changing interactivity and the activities; a remote access handler to remotely access a device of the at least one client and to interact with secondary devices connected to the device; a remote software handler to handle communications related to at least one of software installations, upgrades and changing configurations to the device; a ticket input form builder to gather and fill the ticket with related information; a ticket displayer to prepare a representation of multiple parallel activities and interactions of the ticket for display; and an association manager to handle associations between the ticket, the at least one client and the at least one agent.

Moreover, in accordance with a preferred embodiment of the present invention, the association manager includes a privilege/role manager to assign rules and privileges to the at least one agent for the communication system; and an agent set handler to handle associations of the at least one agent with the at least one ticket.

Further, in accordance with a preferred embodiment of the present invention, the inbox/feed subsystem includes an inbox generator to generate and update a feed of at least one ticket for the at least one agent; a feed displayer to dynamically generate a user interface (UI) element to display the feed; and a dynamic view constructor to construct at least one view to display a list of agents registered with the communication system and their associated activity information.

Still further, in accordance with a preferred embodiment of the present invention, the inbox generator includes a feed constructor to construct the feed, a feed updater to update the feed according to activity information and requirements of the at least one agent; a feed manager to manage multiple feeds; a query receiver and executor to instruct the feed constructor according to results of a query placed by the at least one agent; and an information deriver to instruct the feed constructor according to information derived from the at least one ticket.

Additionally, in accordance with a preferred embodiment of the present invention, the DGRA subsystem includes at least one of: a data gatherer to gather and record information associated with tickets, their interactions and the activities of the at least one agent; and a data analyzer to analyze the information and to generate automated actions accordingly for the ticket subsystem and the inbox/feed subsystem.

Moreover, in accordance with a preferred embodiment of the present invention, the data analyzer includes at least one of: an agent activity manage to analyze and rate agent activity of the at least one agent; a recommender to make ticket assignment recommendations for managers of the at least one agent; a best practice analyzer to recognize and highlight best practices for the at least one agent; an insight generator to generate insights according to patterns or trend analysis for the information; a notification generator to generate alerts and notifications for pre-defined situations; an auto configurer to generate configuration changes for the communication system; an internal content generator to generate content for the KB creator and editor; a ticket prioritizer and tagger to provide priority and tag information for the at least one ticket; a BI (business information) analyzer to integrate business information from the supported system; and an automation trigger generator to activate automation actions according to pre-defined rules.

Further, in accordance with a preferred embodiment of the present invention, the KB creator and editor includes at least one of: a KB editor to provide authoring and design tools for the creation of embedded training material and courseware for the at least one agent and the at least one client; a KB collection creator to create a collection of knowledge base articles for use by users of the supported system, a KB widget creator to create a widget embedded in a website to present knowledge base articles; and a KB processing engine to automatically select, recommend, create, modify or adapt knowledge-based content according to the gathered information.

Still further, in accordance with a preferred embodiment of the present invention, the at least one ticket includes at least one of: the status of interactions between the at least one agent and the at least one client, opening events, closing events, display forms and questionnaires, notes of the at least one agent, ticket meta data, links to related tickets, knowledge base content, ticket association information.

Additionally, in accordance with a preferred embodiment of the present invention, the at least one communication channel is at least one of: a social network, email, a shared virtual space, a web service, an organized communication system, an online forum, an online chat room and a messaging system.

Moreover, in accordance with a preferred embodiment of the present invention, the feed displayer creates a combined user interface showing different levels of the multiple channels of interactivity for the incoming event.

Further, in accordance with a preferred embodiment of the present invention, the ticket displayer displays a single ticket display representing the activities and the multiple channels of interactivity.

Still further, in accordance with a preferred embodiment of the present invention, the ticket displayer displays a summarized version of the multiple channels of interactivity according to an analysis of stored communication data by the rule engine.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are schematic illustrations of a communication system associated with a supported system, constructed and operative in accordance with the present invention;

FIG. 2 is a is schematic illustration of a typical representation of a website building system of the prior art;

FIG. 3 a schematic illustration of the communication system of FIG. 1B integrated with a website building system, constructed and operative in accordance with the present invention;

FIG. 4 is a schematic illustration of the multiple channels of communication used by the communication system of FIGS. 1A and 1B; constructed and operative in accordance with the present invention;

FIG. 5 is a schematic illustration of the sub elements of communication system of FIGS. 1A and 1B, constructed and operative in accordance with the present invention;

FIG. 6 is a schematic illustration of an example ticket, constructed and operative in accordance with the present invention;

FIG. 7 is a screenshot example of the working screen of an agent working with the communication system of FIGS. 1A and 1B; constructed and operative in accordance with the present invention;

FIG. 8 is a screenshot example of an agent display showing an example ticket with an attempted client communication, constructed and operative in accordance with the present invention;

FIG. 9 is a schematic illustration of the elements of the ticket subsystem of FIG. 5, constructed and operative in accordance with the present invention;

FIG. 10 is a schematic illustration of illustrates an example user interface for an inbox feed, including an active and a non-active section, constructed and operative in accordance with the present invention;

FIG. 11 is a schematic illustration of the elements of the inbox/feed subsystem of FIG. 5, constructed and operative in accordance with the present invention;

FIG. 12 is a schematic illustration of an example user interface showing the status of agents of the communication system of FIGS. 1A and 1B, constructed and operative in accordance with the present invention;

FIG. 13 is a schematic illustration of the sub elements of the knowledge base (KB) creator and editor of FIG. 5, example UI displaying a list of agents, constructed and operative in accordance with the present invention;

FIG. 14 is a schematic illustration of the sub elements of the data gathering, recording and analysis (DGRA) subsystem of FIG. 5, constructed and operative in accordance with the present invention; and

FIG. 15 is a schematic illustration of example of trigger activation scenarios, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that in order to efficiently service their customers, the prior art systems as described require an option for sophisticated communication between groups of people within the same organization that can cooperate together to work with, interact or support people outside of the organization. Such a communication made be made via the web or other internet environments, via virtual/augmented reality environments or via other non-web platforms and environments. These outsiders may typically be referred to as clients (though sometimes referred to as users or end-users).

The clients can be external to the organization operating the system (herein “the organization”) such as a client that is an end-user of a company's services. The client may also be internal to the organization such as a company worker calling an internal help desk.

Applicant has further realized such a system should be a multi-channel structured communication system that integrates a dynamic display of communication channels having multiple interactivity levels. Such a system should also provide structured handling and management of such channels together with underlying data gathering and analysis together with a level of automation based on the gathered data. Applicant has also realized that such a system may be standalone or may be used in conjunction with an underlying supported system such as for embodiments involving customer support.

An example of such a supported system is a website building system (WBS) or an e-commerce system. In the case of a website building system, the users of the website building system i.e., the designers or the end-users of the designed websites are the potential clients contacting the agents (working for the website system vendor through the communication system).

Applicant has also realized that the system could support novel features such as the generation of a one-inbox display generated from multiple channels of different interactivity which should be handled according to the interactivity. The system should also be able to display activities with different levels of interactivity, combine immediate and long duration communication, combine synchronous and asynchronous communication and combine non-communication activities. These may include non-communication activities such as a user's client device intervention. The intervention may include install, upgrade, update, configure etc.

Applicant has also realized that the systems of the prior art typically involve rigid assignment and routing of tickets rather than allow agents the ability to watch feeds and manually select and join specific tickets or be assigned based on agent performance parameters.

The system should further combine in-going and out-going communication and combine one-way and two-way communication.

Applicant has further realized that the inventive system should also have at least two levels of involvement with a ticket. For example, one level could be ticket owners or subscribers, and another may be participants in specific activities such as a conference call. The system should allow sorting and selecting by interactivity levels for composite tickets and additional criteria. Tickets are discussed in more detail herein below.

The user interface with the ticket should also show dynamic interactivity designation based on content and/or communication analysis (e.g., a long chat session in which nothing happens) and the ticket display should include multiple activities and interactions, allowing for tracking and participation in multiple interactions of different interactivity levels. The system should also allow the use of a mini player for interaction display.

Other features should include the generation of an inbox display for tickets from a specific viewpoint, e.g., show what a given agent is seeing (with or without using the agents selection/sorting criteria) and the ability to transform channels according to the agent connection method.

The system should further support data analysis using a rule engine (employing artificial intelligence (AI) and machine learning (ML) techniques) including the recognition of best practices, insight, system configuration changes, article generation and bot integration. Bot integration should include human to bot and bot to human transition.

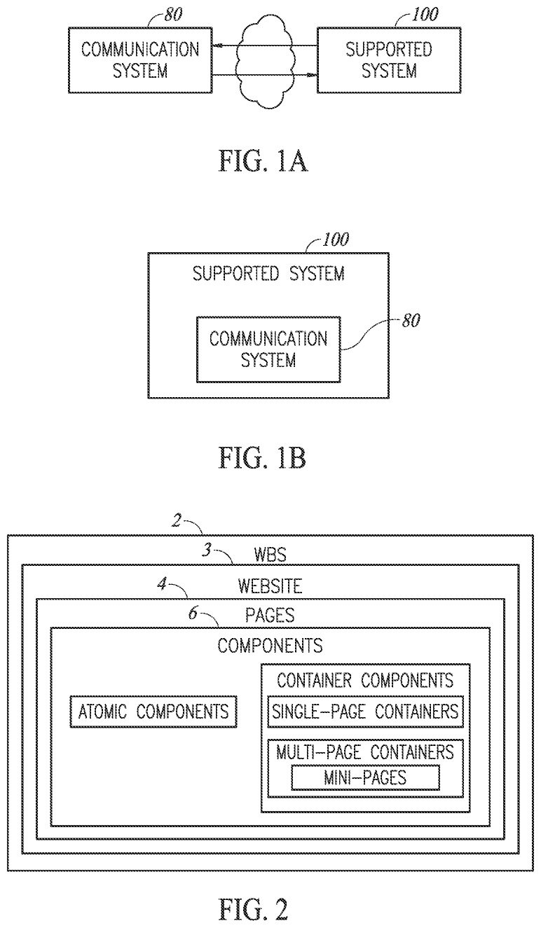

Reference is now made to FIGS. 1A and 1B which illustrate two different embodiments of the implementation of communication system 80 with a supported system 100 according to an embodiment of the present invention. FIG. 1A illustrates a standalone or separate system 80 in communication with supported system 100 and FIG. 1B illustrates an integrated version.

It will be appreciated that communication system 80 may handle communication between an agent (of supported system 100) and a client, as well as communication involving multiple agents and/or multiple clients. The latter case may arise, for example, in a multi-level client situation, e.g., a support issue involving a product company, an external distributor who sold and installed the product and the actual end-user who purchased the product. Another case would be providing support for a system 100 whose operation involves the cooperation of multiple users/clients. Thus, users of system 80 may be clients and agents

As discussed herein above, supported system 100 may be a website building system (WBS). A WBS typically handles the creation and editing of visually designed applications (such as a website) consisting of pages, containers and components. Pages may be separately displayed and contain components. Components may include containers as well as atomic components. Reference is now made to FIG. 2, which is a schematic block-diagram illustration of a website building system (WBS) 2 which may be used for building a website 3, in accordance with some demonstrative embodiments of the present invention. WBS 2 may be used to build, produce, edit and/or generate website 3, which may comprise pages 4 which may include components 6 (e.g., text, images, videos).

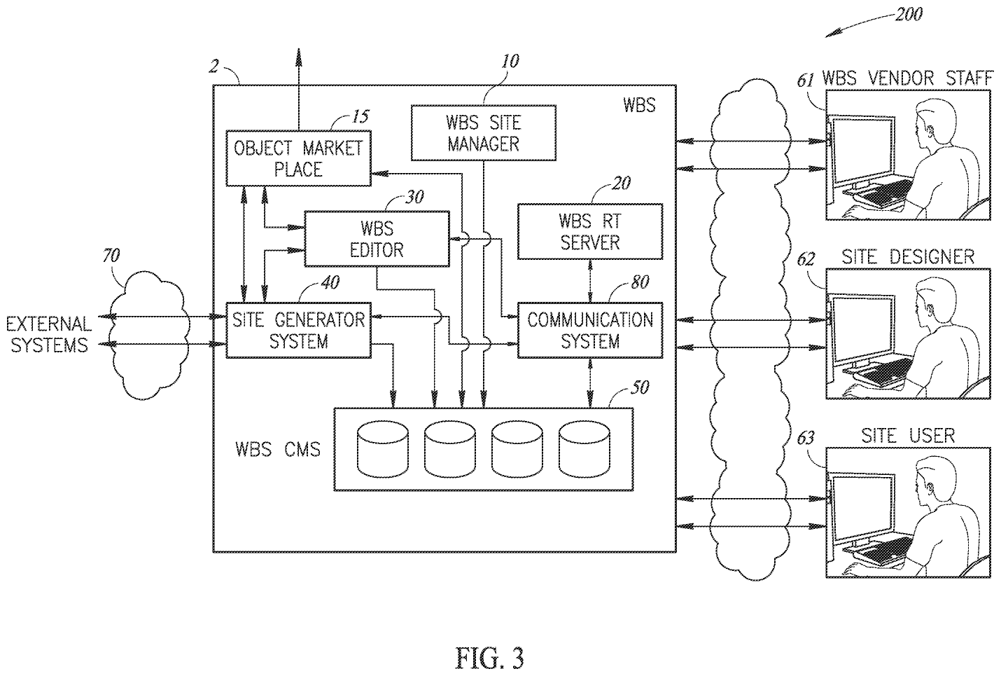

Typical site creation may be based on a number of models, including a visual editing model (in which the user edits a previously created site) and an automatic site generation model or a combination thereof as illustrated in FIG. 3 to which reference is now made and is described in U.S. Pat. No. 10,073,923 entitled “System and Method for the Creation and Update of Hierarchical Websites Based on Collected Business Knowledge” granted 11 Sep. 2018, commonly owned by the Applicant and incorporated herein by reference.

FIG. 3 illustrates an integrated system 200 according to an embodiment of the present invention that comprises a typical WBS 2 in communication with client systems operated by WBS vendor staff 61, a site designer 62 (i.e. a user), a site user 63 (i.e. user of user) and with external systems 70. WBS 2 may further comprise a WBS site manager 10, an object marketplace 15, a WBS RT (runtime) server 20, a WBS editor 30, a site generation system 40, a WBS content management system (CMS) 50 and a communication system 80. It will be appreciated that user and site information as stored in CMS 50 may be used for analysis (as described in more detail herein in below).

Thus, there may be a two-way integration between communication system 80 and supported system 100 which may involve two-way data access, use of communication channels and possible integration of a system 80 UI (user interface) hosted within the supported system UI. This may differ from regular third-party integration in which one system primarily provides services to the other.

It will be appreciated that the description below refers to people (e.g. members, employees, or consultants) of a single organization. However, communication system 80 may also be deployed for use by a set of cooperating people from multiple organizations.

It will be further appreciated that communication system 80 may also support fully automated nodes (e.g. bots or other computerized elements communicating with communication system 80) as well as semi-automated nodes (such as a person communicating through communication system 80 which is assisted in his or her communication by automated means) as described in more detail herein below.

It will also be appreciated that either side may initiate the communication, the client (e.g., a client calling a customer support line) or supported system 100 (e.g., a sales organization making an outgoing call to potential clients). An initiated communication may be synchronous (e.g., video conference), asynchronous (emails going back and forth), or both. The communication may also be able to switch both mode and/or direction. For example, an incoming customer email may trigger an outgoing video call.

The following description describes a communication system 80 in the context of a customer support system, though it can be applied in multiple application areas, such as a sales center (incoming and outgoing), a stockbroker, an ordering center, a telemedicine call center, an IT help desk, internal communication (structure communication) and internal knowledge base construction and use.

Communicating members of the organization or supported system 100 may be referred to as “agents” (e.g., support agents), though they may not be actual agents. For example, for an embodiment of communication system 80 in a customer support center operated by a software company, the interaction may involve actual support agents (known as customer-facing agents) as well as other employees of the organization (such as employees from quality assurance (QA), product, documentation or engineering teams). Also, in other situations (besides customer support) “agents” may have completely different roles within their organizations. It will be appreciated there are roles within the agent's actual organization, rather than roles within communication system 80 (which are discussed in more detail herein below).

It will also be appreciated that some embodiments of communication system 80 may call for tighter integration with supported system 100. For example, supported system 100 may display different variants of a “call support” widget or UI element, which could be used by the user to initiate support while providing context and data to the inventive system specific to the supported system area invoking the support.

System 80, agents and clients may communicate through different channels, having different levels of interactivity. Interactivity is defined in this case based on the level of engagement of the communicating parties, as well as the expectation for rapid response.

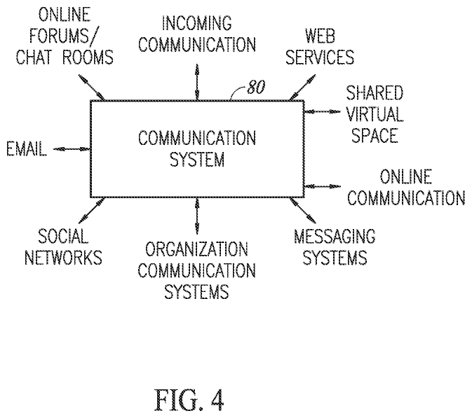

Reference is now made to FIG. 4 which illustrates communication system 80 in 2-way communication using different examples of communication channels. It will be appreciated that this may be implemented using a suitable interface. Channels can include but not be limited to direct online communication such as phone calls/VOIP (Voice Over Internet Protocol), live chat, video conference/chat, shared virtual spaces (Virtual Reality/Augmented Reality based) and messaging systems, such as WhatsApp (commercially available from Meta Platforms, Inc.), Telegram (commercially available from Telegram.org), or SMS (Short Messaging System).

Channels may also include organizational communication systems, such as Slack (commercially available from Salesforce) and social networks, such as Facebook (commercially available from Meta Platforms Inc) and Twitter (commercially available from Twitter, Inc.), typically including multiple means of communications inside them (e.g., posting/responding, direct messaging and built-in chat).

Other communication channels may be via email, on-line forums and chat rooms and incoming communication such as contact forms, IVR (Interactive Voice Response) collected information, incoming fax or fax to email. Such communication may continue through other (mostly on-line) channels.

Web services or other process-to-process or system-to-system communication methods may also allow for automated communication sources to participate. Such sources may be initiators (e.g., automatically making a sales call, sending an invitation email or calling support to report on a system issue) as well as responders (e.g., support agent-bots as discussed in more detail herein below). Another form of communication channel could be any type of shared virtual space, such as jointly edited document, spreadsheet, whiteboard, drawing space (2D or 3D), virtual environment or other shared spaces.

It will be appreciated that many of these channels can involve multi-party communication (when applicable), e.g., including multiple agents and/or multiple clients.

It will be further appreciated that some of these channels may have different states at different times. For example, a chat session between an agent and a client may be silent for a while, or be in a state of “typing . . . ”, i.e., one of the parties is about to send a message. Such states may be associated with the channel's level of interactivity, e.g., an active chat session is regarded as having higher interactivity than one which has not been active for a while. States can also be associated with a delivery status, e.g., was the message sent, seen, read or unread.

It will also be appreciated that the interactivity state definitions for a given channel type does not have to form a discrete set. Some channels may provide a continuous (or semi-continuous) interactivity level indication, based (for example) on time since the last interaction.

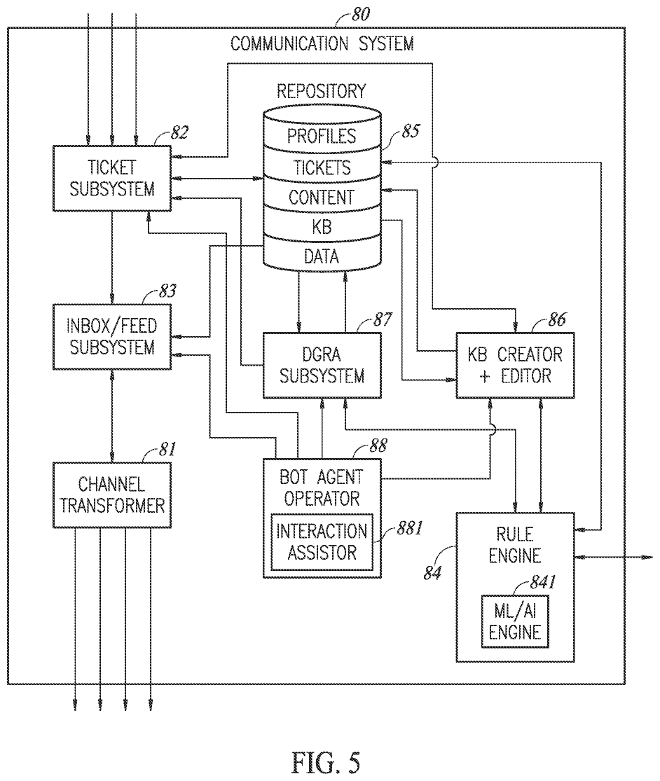

Reference is now made to FIG. 5 which illustrates the different elements of communication system 80.

Communication system 80 may comprise a channel transformer 81, a ticket subsystem 82, a inbox/feed subsystem 83, a rule engine 84, a repository 85, a knowledge base (KB) creator and editor 86, a DGRA (Data Gathering, Recording and Analysis) subsystem 87 and a bot agent operator 88. Rule engine 84 may further comprise an AI (artificial intelligence)/ML (machine learning) engine 841. Bot agent operator 88 may further comprise an interaction as sister 881. The functionality of these elements is described in more detail herein below.

Repository 85 may store information and parameters for tickets both opened and closed (live or archived), including tickets history, interactions and communication data. Repository 85 may also store data to be used for analysis, automation, reporting, visualization, management and other purposes together with rules for rule engine 84 as described in more detail herein below. Repository 85 may also store agent profiles and management data as described in more detail herein below.

Channel transformer 81 may allow agents to connect to system 80 in multiple ways (such as telephone, regular display, VR, etc.), by adapting the UI of communication system 80 to the agent's preferred communication method. It will be appreciated that channel transformer may do this using information provided to the server, through code running of the client, or though parts of channel transformer 81 running on the client itself. Channel transformer 81 may also adapt the communication itself. For example, for an agent providing support through a small screen smartphone, channel transformer 81 may use down scaled video instead of the full-scale video used for desk top connected agents.

Channel transformer 81 may implement some of the envisioned channels in several ways, such as internally (implement its own video conferencing client or server infrastructure), integrated with external systems implementing the relevant communication channel, (such as integrated with the Zoom Video Conferencing system by Zoom Video Communication Inc. to provide video conferencing channels) or through integration with supported system 100. For example, in this integrated scenario, a website building system (WBS) supported system may provide a “call support” widget or other UI elements which may be integrated with sites built using the WBS.

It will be appreciated that all the activity of communication system 80 may be arranged around tickets. It will be further appreciated that although the terminology of ticket is common to customer support related prior art, communication system 80 may be used for other application areas as described herein above.

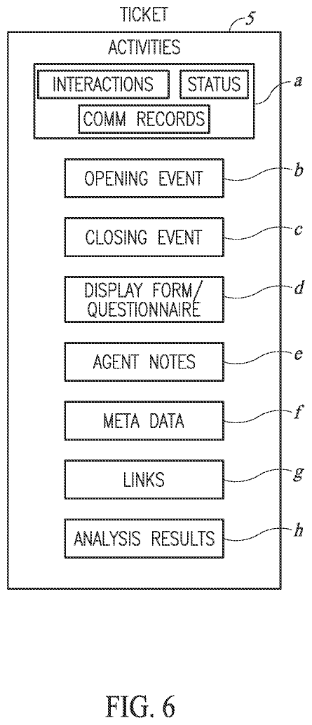

Reference is now made to FIG. 6 which illustrates a generic ticket 5 for use within communication system 80. It will be appreciated that a ticket may be created for an incoming event or concern, may include many elements and that no two tickets may be alike. Ticket 5 may comprise elements (not all shown) such as activities (interactions, communication records, status/interactivity level) (a), an opening event/interaction (b), a closing event/interaction (c), display forms and questionnaires (initial forms, in-ticket forms, post-contact forms) (d), representative activities indication, agent association information, links to related tickets, agent notes (c), attached files, ticket metadata (f), external/internal links (g) (internal links/URL, related information, external links to elements of supported system 100, linked knowledge base articles), analysis results (h), event records, ticket labels/text, ticket status (information/events from supported system 100, extracted information, support/interaction related information) and system added information (analysis results and recommendations and extracted/derived information).

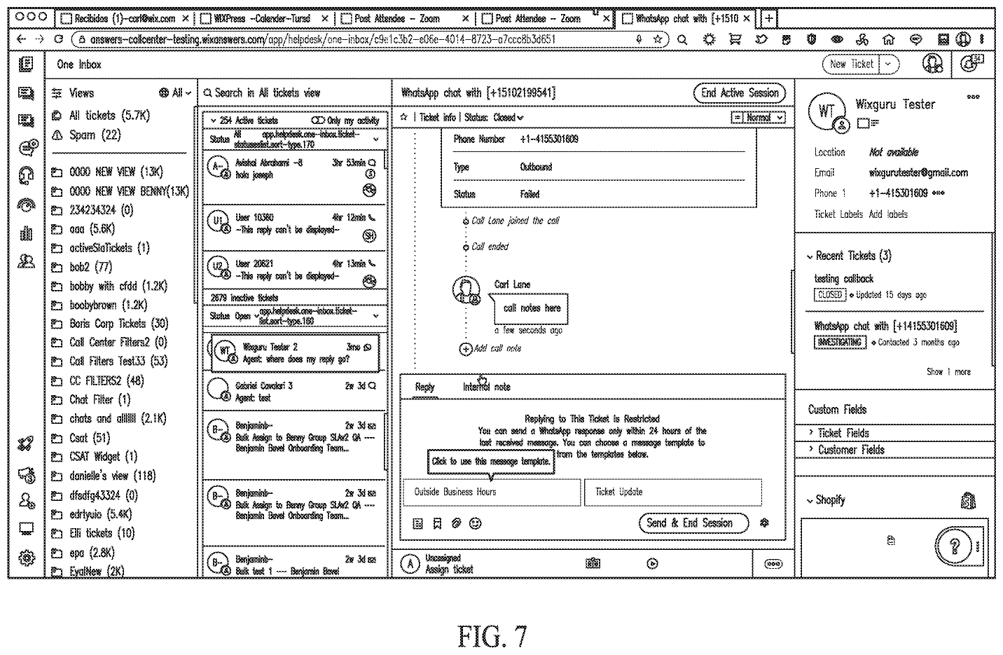

Reference is now made to FIG. 7 which illustrates an example of an agent's working screen, including a list of views, an active and non-active ticket list, and a specific ticket display. The displayed ticket includes a WhatsApp chat interaction as well as call notes.

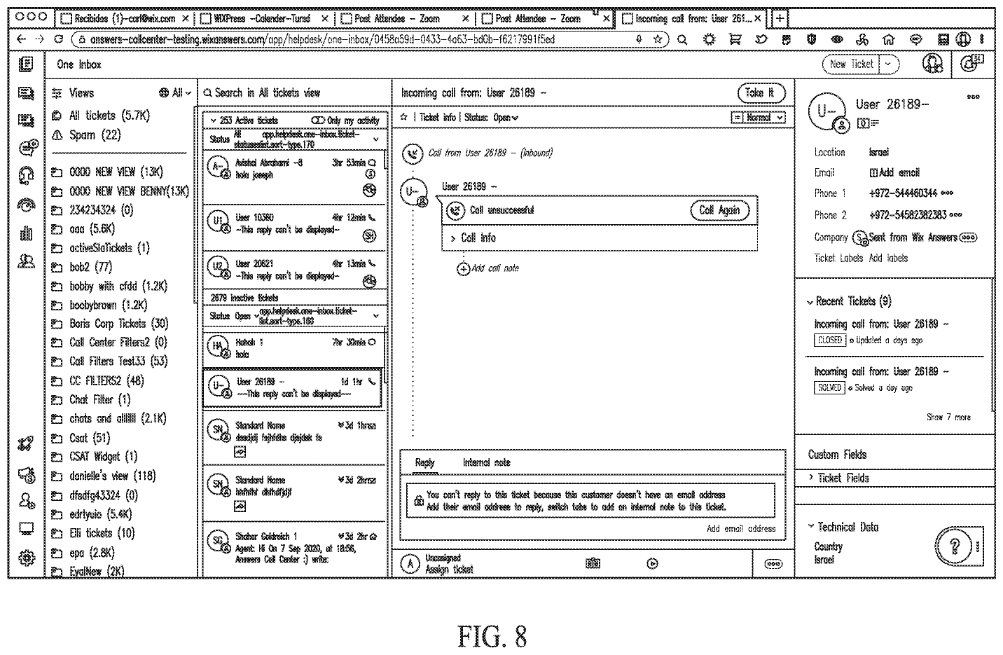

Reference is also made to FIG. 8 which illustrates an agent display showing an example ticket with attempted client communication.

As discussed herein above rule engine 84 may comprise an AI/ML engine 841 which may employ AI and ML techniques to service the elements and sub elements of system 80. It will be appreciated that any ML models used may be any suitable model for the pertinent task or activity. Machine learning models are known in the art and are typically some form of neural network. The term refers to the ability of systems to recognize patterns on the basis of existing algorithms and data sets to provide solution concepts. The more they are trained, the greater knowledge they develop. It will be appreciated that AI/ML engine 841 may also train models using data external to system 80 (i.e. not stored in repository 85).

The ML models used may be learning models (supervised or unsupervised) as described in more detail herein below. As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DB scan), or Bayesian methods (e.g., Naive Bayes, Bayesian model averaging, Bayesian adaptive trials), image to image models (e.g. FCN, PSPNet, U-Net) sequence to sequence models (e.g., RNNs, LSTMs, BERT, Autoencoders) or Generative models (e.g., GANs).

Alternatively, ML models used may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models 317 may be generative models (such as Generative Adversarial Networks or auto-encoders) to generate solution elements (such as website building system elements and media objects).

For most embodiments, the ML models used may undergo a training or learning phase before they are released into a production or a runtime phase or may begin operation with models from existing systems or models. During a training or learning phase, the ML models may be tuned to focus on specific variables, to reduce error margins, or to otherwise optimize their performance.

ML models may be implemented with rule-based systems, such as an expert system or a hybrid intelligent system which incorporates multiple AI techniques. These are discussed in the articles in the Wikipedia entitled “Rule-Based System” and “Hybrid Intelligent System”, at en.wikipedia.com.

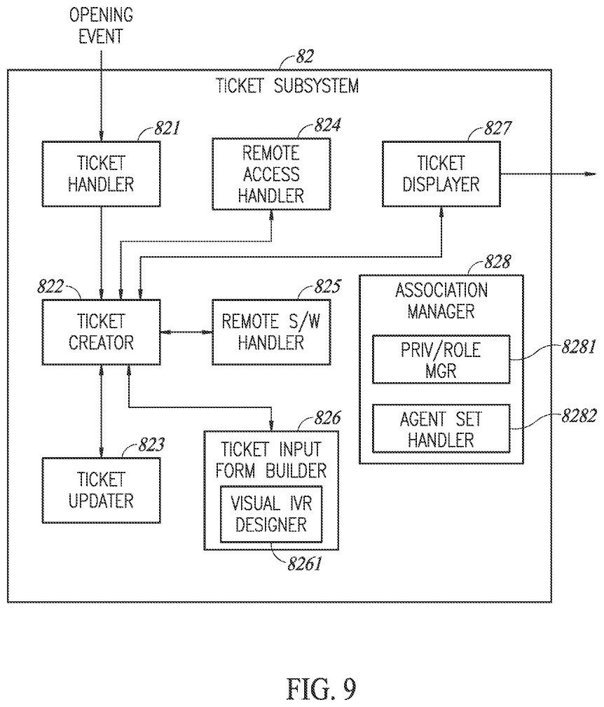

Ticket subsystem 82 may be responsible for the creation, handling and implementation of tickets. Reference is now made to FIG. 9 which illustrates the elements of ticket subsystem 82. Ticket subsystem 82 may comprise a ticket handler 821, a ticket creator 822, a ticket updater 823, a remote access handler 824, a remote software handler 825, a ticket input form builder 826, a ticket displayer 827 and an association manager 828. It will be appreciated that ticket subsystem 82 may also incorporate into tickets the output of KB (knowledge base) creator and editor 86 and DGRA subsystem 87 as described in more detail herein below.

As discussed herein above, a single ticket 5 may include a set of activities. A primary activity type may be interactions between the agent(s) and the client(s) regarding a single event or concern.

It will be further appreciated that ticket 5 may include a variety of time-related elements (which may be instantaneous or occur over a period of time). Such elements may include (for example): interaction activities (such as an email or a video-conference), non-interaction activities (such as remote access to the user's machine or online feedback form filling), agent association activities (such as an agent or an agent group joining or leaving the ticket) and additional information such as internal notes, attached media, links to other tickets or data. Further elements may include system-added information, such as results of business information (BI) analysis, recommendations made by KB creator and editor 86 and DGRA subsystem 87, extracted or derived information (such as call transcripts or client voice/emotion analysis), etc. Ticket 5 may also include non-time-related elements, such as meta-data and ticket parameters.

Ticket handler 821 may receive a particular opening event or interaction (e.g., a client calls in via phone or video chat, or sends a support request email) and may instruct ticket creator 822 to create a ticket 5. In an alternative embodiment, ticket 5 may be explicitly created. It will be appreciated that ticket 5 may also have a closing event (e.g., the ticket had been closed by an agent once a problem has been resolved) which may arise from a trigger rule (“close pending tickets after 72 hours”) as described in detail herein below.

Ticket updater 823 may update tickets accordingly due to changing activity, statuses and collected information (e.g., as the ticket accumulates additional information related to problem description and resolution). Ticket updater 823 may also include recommendations as provided by DGRA subsystem 87 as discussed in more detail herein below.

Remote access handler 824 may remotely accesses the client's machine (or another client device such as a smartphone). This could be, for example, through a regular remote access platform or through a specific capability integrated with supported system 100.

Remote access handler 824 may also interact with secondary devices connected to the client's device such as industrial or other equipment connected to a client device (e.g., to support an industrial installation) or medical sensors or other devices connected to the client device (e.g., to support a tele-medicine application).

It will be appreciated that ticket 5 may also include activities that are not interactions or otherwise communication via one of the channels. Remote software handler 825 may handle activities causing interventions in which an agent initiates a software upgrade, installation or re-configuration at the client site, or on a server (or other sub-system) related to the supported system. Such an activity is not a person-to-person communication, but could still be a substantial event. Such activities could also be instantaneous or not (e.g., a large-scale software upgrade may take a few hours to complete).

Ticket input form builder 826 may gather and fill the required ticket information as described in more detail herein below.

Ticket displayer 827 may prepare a single ticket display (such as showing the various activities within the ticket). This could be a separate area in the full display (as generated by inbox/feed subsystem 83) or could be integrated with the feed or inbox display (e.g., displaying lists of tickets with some elements the single ticket display). It will be appreciated that the display for ticket 5 may include combining any immediate and long duration communications, combining any synchronous and asynchronous communication and combining non-communication activities such as any client interventions (as described herein above). It will be appreciated that the ticket 5 display by ticket displayer 827 may include a representation of the multiple parallel activities and interactions (some of which may be “open” concurrently). For example, the reply to area (or “reply box”) is typically at the bottom, and system 80 may allow a single reply to area to serve multiple communication channels (such as chat, email, SMS, social media, and others), with the agent specifying to which of the open channels he or she would like to respond (based on the available channels).

Ticket displayer 827 may show long interactions (e.g., phone calls) as parallel activities (as shown in FIG. 7 back to which reference is now made). Alternatively, it could also show start/end markers for the relevant long interactions (with shorter or intersecting activities showing their own markers in the appropriate points). Ticket displayer 827 may further show processed versions of long interactions, e.g., extracted frames from a long video call or a screen sharing sessions, extracted audio segments or extracted stages from a remote intervention session (such as the different stages in a software upgrade performed remotely on the client's machine). To do this, ticket displayer 827 may extract the relevant stored communication data, may analyze it (possibly using AI/ML engine 841) and may summarize it to create a summarized version of relevant parts of the long interaction. The analysis function can provide further training material for AI/ML engine 841 (as described herein below) based on the actual usage of agents, or feedback provided by them as to the quality of extraction, analysis and summarization.

It will be appreciated that multiple agents may be associated with a single ticket 5, and may join or leave the association. Thus, ticket 5 does not “move” between agents (with the original agent losing visibility of the ticket and its activities). Rather, each ticket 5 may have an agent set which changes over time.

Association manager 828 may handle associations between tickets, agents and clients and may expand or shrink an association as necessary. Association manager 828 may further comprise a privilege/role manager 8281 and an agent set handler 8282.

It will be appreciated that association manager 828 may associate tickets using not just the assigned agent identities, but additional association information. For example, agent set handler 8282 may include agent contact information (e.g., communication channels ID's (identifiers) or credentials), and may support multiple such sets of information per agent. Thus, for example, a client could be contacting an agent through a work smartphone, and the agent may desire to switch to another smartphone and continue the interaction. Similarly, the agent may want to switch from one agent email to another. Agent set handler 8282 may support these changes in assignment and “sub assignment” and the continuity of the interaction.

It will be appreciated that the agents associated with ticket 5 may be generally regarded as equivalent to each other. However, agent set handler 8282 may designate a primary owner, which is the main one associated with ticket. This could be according to the agent which opened the ticket (or was the 1st responder if automatically opened and assigned to multiple agents), the agent involved in the primary interaction (as defined above) or may be automatically determined based on analysis of the interactions (including their type, volume or content);

Agent set handler 8282 may also change the owner over time (possibly independently from the ticket assigned agent set).

Privilege/role manager 8281 may assign specific roles to specific agents, e.g., an agent which is responsible for making sure that the ticket is closed (which may be different than the initial agent receiving the call). These may be common roles (such as team members, admin) or custom-defined roles.

Different communication system 80 users may have specific privileges related to agent assignment such as managers and administrators who have specific privileges within the group of agents they manage.

Privilege/role manager 8281 may define specific privileges related to use of or access to system resources. For example, some finance related knowledge base articles may only open to specific agents. Similarly, the user of system resources (including the ability to interact) may be limited, e.g., only specific agents may contact senior technology developers within the organization so to involve them with client tickets.

Privilege/role manager 8281 may also allow managers (i.e., with the appropriate privileges) to add or remove agents from a given ticket, or to move a ticket from one agent to another. It may also allow non-manager agents to “invite” other agents to join, based on specific agent identifier or agent attributes (“find me an agent which is familiar with product X”). It may also allow agents to disassociate from a given ticket, possibly limiting this so that a ticket does not become “orphaned”.

It will be appreciated that system 80 may support the association of agent groups, rather than single agents. For example, a client may complain about performance issues in supported system 100. In such a case, the agent may invite (or order) an association of the “system performance” agent group to ticket 5. Further communication within ticket 5 may thus be routed or rather re-assigned (or involve) all members of the “system performance” group, specific agents from that group (e.g., assigned by a group manager or by the system based on assignment rules).

Agent set handler 8282 may allow separate associations of agents (or groups) at the ticket level and at the activity level. Thus, a ticket may be associated with multiple agents (all of which could track the ticket and include it in the inbox displays), but only subset of them would participate in specific activities (such as a video conference with the client). Such subset may vary from activity to activity.

As discussed herein above, ticket 5 may contain the set of interactions between one (or more) agent(s) and one (or more) client(s) regarding a single issue to be handled, such as the handling of a specific problem encountered by the client. At the simplest level, ticket 5 may include a single interaction. However, ticket 5 may also include multiple interactions as well as other activities.

Ticket 5 may also include interactions between communication system 80 and the client which do not involve an agent. For example, system 80 may display forms and questionnaires, such as an initial form (or another web page or visual application page or widget) which provides the user with a preliminary questionnaire (or other guidelines) to help in problem resolution or information collection. Another interaction may be in-ticket live forms, which can be invoked by an agent to allow a client to provide information to system 80. An example of this is the provision of required data at some phase without extensive agent involvement (“Please fill form X and then we'll return to you with the right solution”), thus supporting issue triage and routing and reassociating for system 80.

A further such interaction may be a post-contact questionnaire to gather feedback on the provided support (or other contact or service). This may support implementation of surveys and data collections.

It will be appreciated that such forms and questionnaires can be visual based or use other technologies. They may include forms designed using ticket input form builder 826, as well as forms designed and/or hosted by the third-party form providers. Ticket input form builder 826 may be used to define fields, flow, and rules controlling rule engine 84 (e.g., validation rules, when/where to send the information and other form behavior definitions and rules). Ticket input form builder 826 may further comprise a visual IVR designer 8261 to provide a design environment for IVR development allowing for the definition and update of IVR interactions for the user.

It will be appreciated that ticket subsystem 82 may also support re-opening a ticket. Ticket handler 821 may re-open an existing closed ticket or create a new ticket linked to one or more previous tickets (e.g., based on interactions with the same client).

It will be appreciated that ticket 5 may include communication channels related to interactions. Such interactions may be instantaneous (e.g., the arrival of a submitted form) or may have a duration (e.g., a phone call or video conference).

Ticket 5 may also include a record of internal communication. For example, a phone call with a client may be followed by an internal video conference (e.g., between customer facing agent and internal engineering team). The record of such a video conference may be part of ticket 5.

It will be appreciated that ticket 5 may also include other elements such as agent notes, e.g., a phone call summary, attached documents or other files and ticket 5 metadata, e.g., top-level description, problem severity, priority, client importance (e.g., is there a VIP support agreement?), description, client details, time of opening, etc. The ticket metadata may also include custom fields, ticket-specific fields, company fields (for the company operating the system), user fields, fields related to the supported system, high level topic definitions (ML (machine learning) generated or manual ones), BI (business intelligence) and hints (possibly selected from tag cloud).

Other ticket 5 elements may also be external or internal links such as links to internet URL's, external records describing the specific sub-elements of supported system 100 relevant to ticket 5, knowledge base articles and the results of analysis of other elements of the ticket. For example, DGRA subsystem 87 may analyze audio or video interactions to create a transcript associated with these calls.

Ticket 5 may also include a record of events related to the tickets, ticket labels/text and any status, including custom status.

It will be appreciated that ticket 5 may also include information received from supported system 100 via ticket updater 823 which may update the pertinent elements of ticket 5 accordingly. For example, system 80 may be used to support users of a WBS (as discussed herein above). Such WBS users could be (for example) site designers, site operators, or site users. Ticket subsystem 82 may add to the ticket's timeline events which represent information extracted the underling WBS. Such information could include user profile details, web site details, collected WBS BI data, WBS editing history and site usage history, site underlying business data etc. as stored in CMS 50 in FIG. 3 back to which reference is now made. These events could also include events occurring as a result of the support interaction, therefore allowing the agent to receive precise information from supported system 100 rather than relying on the client's description of what happens with supported system 100.

It will be further appreciated that ticket 5 may have multiple interactions sequentially or in parallel. For example, while one agent is in a long video conference call with the client, another agent may exchange a series of emails (under the same ticket) with the client and internal teams helping the support agent.

Ticket 5 may represent one of or both of the current “primary” activity, which may be the current and most interactive communication activity between the agent(s) and the client(s). Thus, in the example above (having an agent-client video chat concurrent with multiple emails), the ticket would be represented by the (current) video chat. Ticket 5 may also be represented by the ticket-opening activity or by the last (or otherwise most recent) interaction with the user.

Thus, ticket 5 may be referenced (e.g., based on this primary activity interaction type) as (for example) a “video conference ticket” or a “text chat ticket”, etc. even though ticket 5 may have additional activities (interactions or not) and elements. This primary interaction type may also denote the ticket 5′s level of interactivity (which may change over time based on the various interactions).

In another embodiment, ticket 5 may be represented by a subset of active interactions in the ticket. For example, a complex ticket may have two on-going video conferences (e.g., agent to client and a related internal engineering conference) as well as a live chat (e.g., between another agent and another client employee related to the issue). Such a ticket may be represented by these three active interactions, and would be shown (in a list of tickets) with three icons representing these three concurrent interactions.

A ticket is initially associated with the external client who opened (or possibly more than one such client). Later the ticket may be taken by a given agent, or assigned to an agent (e.g., by a system or by a manager) as discussed herein above.

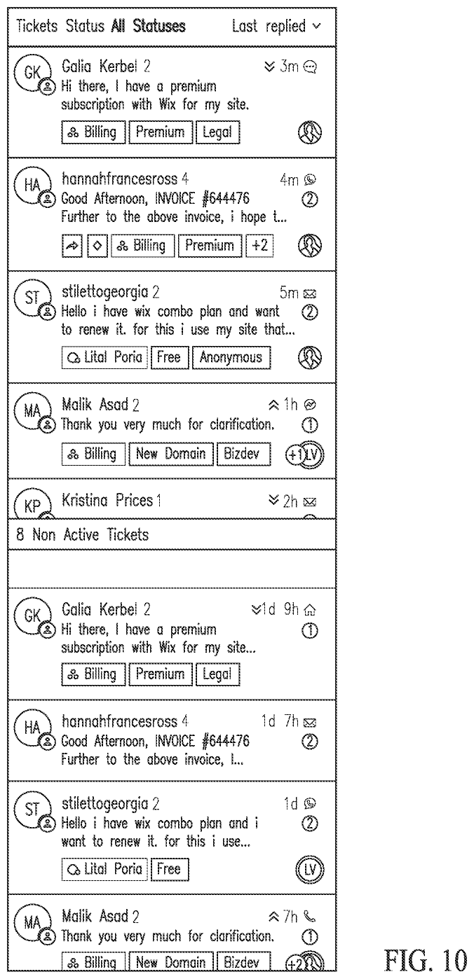

Ticket displayer 827 may provide an interface showing the current status of a particular ticket and provide a single feed for their viewing. An example feed may be a feed used by agents to view the tickets with which they are associated, or a feed used by managers to view the tickets pending in the system, or being handled by specific agents or agent groups. Reference is now made to FIG. 10 which illustrates the details of an example UI of a ticket list (inbox/feed), including an active and a non-active section.

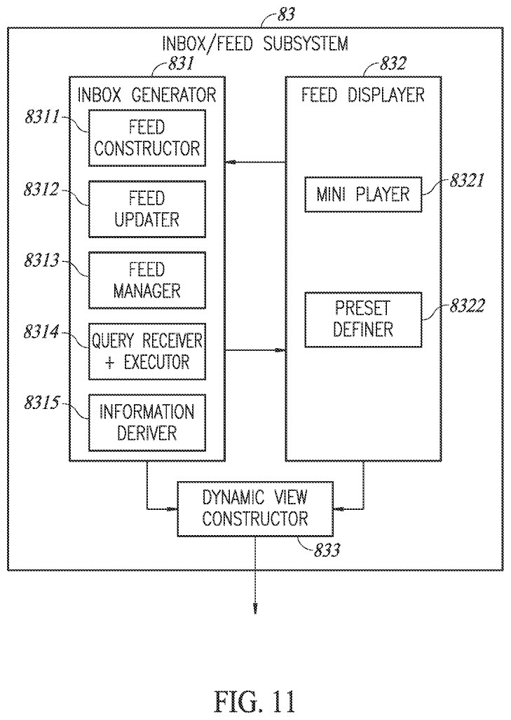

Reference is now made to FIG. 11 which illustrates the elements of inbox/feed subsystem 83. Inbox/feed subsystem 83 may create the feeds and their display of tickets 5. It will be appreciated that the inbox/feed subsystem 83 is the main interface between system 80 and its users. Inbox/feed subsystem 83 may further comprise an inbox generator 831, a feed displayer 832 and a dynamic view constructor 833. Inbox generator 831 may further comprise a feed constructor 8311, a feed updater, 8312, a feed manager 8313 and a query receiver and executor 8314. Feed displayer 832 may further comprise a mini player 8321 and a preset definer 8322.

As shown in FIGS. 7, 8 and 10 back to which reference is now made, inbox/feed subsystem 83 may include tickets with different levels of interactivity and that use different channels. Inbox/feed subsystem 83 may therefore reflect on-going interactive communication (e.g., ongoing messenger chat or video conferences) as well as tickets that are not currently interactive (e.g., tickets based on email exchanges). It will be appreciated that a ticket 5 may have a general level of interactivity (e.g., email is low, video conference is high) as well as a current level of activity (e.g., a chat may be inactive for a long period of time).

Feed displayer 832 may display one or more indicators for either or both levels of interactivity on a combined UI (such as the general inbox together with the current ticket as is illustrated in FIG. 7 back to which reference is now made). Such indicators may include, for example, a current status indicator (e.g., active, non-active, typing . . . , etc.). The indicators may also include an indication of the time since interaction took place in this ticket (e.g., a timer, a symbol, or a scale).

Inbox generator 831 may generate and update multiple tickets feeds for agents. Feed constructor 8311 may construct feeds according to a request, feed updater 8312 may update feeds according to activity and agent requirements, feed manager 8313 may manage multiple feeds, query receiver and executor 8314 may handle feeds based on a query and information deriver 8315 may handle feed based on information derived from a ticket's activities.

It will be appreciated that feed displayer 832 may select, sort, prioritize and group tickets according to the information and meta-data associated with them as described herein above. The ticket sorting and prioritizing may change dynamically based on the interactivity status of each ticket.

Feed displayer 832 may dynamically generate a UI element to display the tickets in a feed, regardless of their type (e.g., interactive and non-interactive and different interaction types). The tickets in the feed may be changed dynamically as the tickets change their nature (e.g., a ticket which started with a non-interactive submitted form may become a highly interactive one reflecting a current video conference).

An agent may also construct a feed based on association information, such as tickets associated with a given agent or group, or tickets which are actually being handled by a given agent. Such a feed could be used (for example) by a manager with the appropriate privileges to track the activity of a given agent or agent group (e.g., based on the definition of the agent group managed by that manager).

A feed may also be based on agent activity, query based or association based. It will be appreciated that query receiver and executor 8314 may receive a query and instruct feed constructor 8311 to create a feed accordingly. This may include, for example, a manager being able to view a specific agent's activity (i.e., replicating the queries used to form a given agents' view). Another example would be “view all chat sessions which involve agents answering criteria X”.

Query receiver and executor 8314 may also instruct the creation of feeds based on the content of the ticket (including the ticket's communication history), e.g., display all tickets in which X was mentioned (in chat, video conference, email, etc.).

Information deriver 8315 may create a feed for display based on information derived from the ticket's activities (e.g., a feed displaying all users from geography X which mentioned product Y and conveyed a sense of urgency about it with a rating above Z %).

Information deriver 8315 may also create a feed based on criteria related to supported system 100, e.g., “view all tickets related to supported system feature X”. Such criteria can also be based on internal elements of the supported system, including its internal structures or collected data. For example, if the supported system is a WBS, the criteria may refer to the WBS's BI (e.g., “show all tickets related to users of web sites with more than X users from country Y”), structure and editing history (e.g., “show all tickets related to sites to which site component X as added in the last month”), etc.

It will be appreciated that feed displayer 832 may display the constructed/updated feeds of tickets and may also receive ticket display instructions from ticket displayer 827. It will be further appreciated that a user may also use the UI of feed displayer 832 to adjust settings such as preferred display.

The ticket display in the feed may represent the on-going interaction(s) in the ticket using a mini-player. Mini-player 321 may reflect different types of information related to a current interaction going on in the ticket, such as the current status (non-active, active, typing . . . , etc.). Mini player 8321 may also reflect the information in the current or recent interaction (e.g., the last email message, last chat message, a scaled down version of a shared screen interaction between the agent and the client etc.) and the information derived from the current or recent interactions, such as text recognized based on analysis of a voice-based interaction, or other metrics derived from voice or video-based interactions (e.g., indicators of stress, urgency, or other relevant emotions). Such derived or analyzed information may also be used as input to DGRA subsystem 87 and rule engine 84 modules as described herein below.

It will be also appreciated that the agent may set (via the view options of the UI of feed displayer 832) the desired type of display (in general and for given tickets). The general display can use (for example), a table display, a list display, etc. The user may define multiple user-defined views (or display modes), including the use of queries as described in more detail herein below. In this scenario, feed constructor 8311 may receive the desired display and construct it accordingly.

An agent may also construct a feed based on association information, such as tickets associated with a given agent or group, or tickets which are actually being handled by a given agent. Such a feed could be used (for example) by a manager with the appropriate privileges to track the activity of a given agent or agent group (e.g., based on the definition of the agent group managed by that manager).

As discussed herein above, ticket 5 may have multiple (and even concurrent) interactions or activities, and may accordingly display multiple mini-players concurrently reflecting the status of some or all of the underlying interactions (or other relevant activities) of the ticket.

It will be appreciated that an agent may construct multiple such feeds (or inboxes) based on multiple criteria and their combinations, such as ticket types, communication channel type, level of interactivity (including current interactivity), priority, or other ticket or activity parameters and attributes. Feed constructor 8311 may also function automatically (in push mode) rather than following the agent's instructions.

As discussed herein above, inbox generator 831 may construct a feed based on queries that select and order tickets. Such queries may relate to activities within a ticket, and there may be multiple such activities within a ticket (historically or concurrently). For example, an agent may request a feed displaying all active chat calls, and some tickets may contain multiple active chat calls. Feed displayer 832 may use, for example, a regular display (displaying each ticket as an entry in the feed), a split feed (displaying multiple entries per ticket containing multiple chats) or a hierarchical feed (allowing the opening of some “tickets with chat” entries to display the multiple active chats).

Preset definer 8322 may divide the feed into multiple sections, such as active and non-active sections. Preset definer 8322 may also enable an agent to define multiple presets, which may include a definition of an inbox feed, including its selection criteria and its sorting criteria.

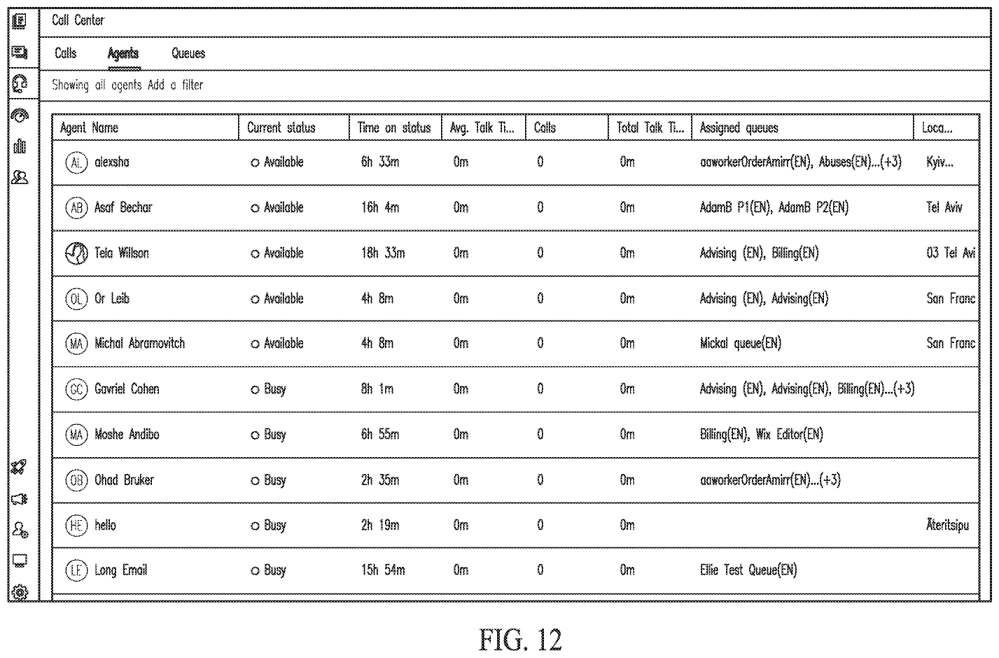

Dynamic view constructor 833 may construct views that show lists of agents rather than lists of tickets as is illustrated in FIG. 12 to which reference is now made. An example would be showing all agents handling a given client, client group (e.g., by profile attributes), products etc. As discussed herein above, inbox/feed subsystem 83 may use derived information from activities, including dynamically extracted information. The list of agents derived from activity information may also be used by system 80 (and by the agent managers using it) to monitor agents, understand their workload, and make adjustments to where agents are assigned them based on this information.

As discussed hereinabove, communication system 80 may comprise a repository 85. Repository 85 may also store content, known as knowledge base. Knowledge base content may typically include written articles, which may be connected to each other. However, knowledge base content may also contain elements such as other media types (such as training, support or how-to videos), applications and software elements (such as interactive training application) and elements which relate to supported system 100. For example, if supported system 100 is a WBS, knowledge base content may include links to a template or component library for use with the underlying WBS. These could be provided to a user to help in the site design work.

Knowledge base content may also include content snippets, re-usable elements for knowledge base articles, as well as articles which include repeating elements. System 80 may support the use of inheritance among such elements and articles, allowing the building of articles and article sections which re-use previously defined material (possibly with local modification).

Other knowledge base content may include add-on software, plug-ins, data or configuration information (as files or otherwise) to be installed on the client's machine or system, or on a server machine associated with the client. This may include, for example, add-on code or data/configuration/settings for use with the underlying supported system 100.

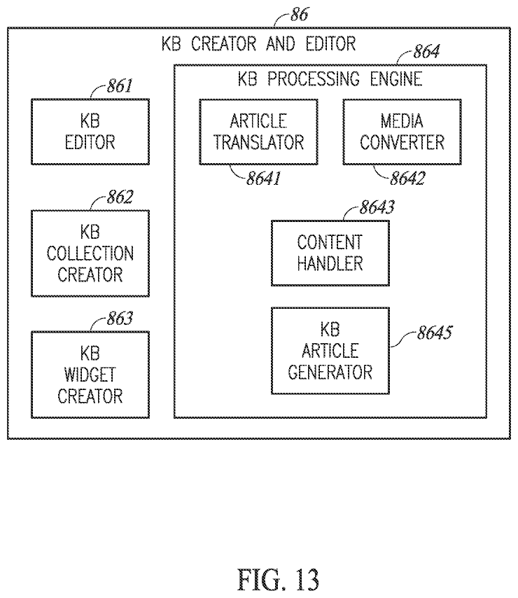

KB creator and editor 86 may support the creation and editing of all knowledge base content for use by the elements of system 80. Reference is now made to FIG. 13 which illustrates the elements of KB creator and editor 86. KB creator and editor 86 may comprise KB editor 861, KB collection creator 862, KB widget creator 863 and KB processing engine 864. KB processing engine 864 may further comprise an article translator 8641, a media converter 8642, a content handler 8643 and a KB article generator 8645.

KB editor 861 may provide authoring and design tools for the creation of embedded training material and courseware as discussed herein above. Such material may be aimed at both agents and clients.

It will be appreciated that such knowledge-based articles or other content may be used in a number of ways. They may be provided automatically to incoming clients (based on the parameters of the initial interaction), provided to agents to be delivered to clients, provided to agents for their internal use or they may be installed as add-on software, configuration or data in client's machine or system.

KB collection creator 862 may use knowledge-based articles and content to generate a collection that is exposed on the internet to customers (e.g., through a specific web site or a branded help center).

KB widget creator 863 may generate a widget to present knowledge base articles that can be embedded in any website (based on a WBS supported system, other WBS' s or non-WBS web sites).

KB processing engine 864 may automatically select, recommend, create, modify or adapt knowledge-based content according to gathered information (e.g., from input forms and questionnaires as discussed herein above) and the context (e.g., information about the agent(s), the client(s) and the problem issue covered by the ticket). The modification or adaptation of the content may also include automatic translation.

Article translator 8641 may automatically translate any content to a different language as pre-defined.

Media converter 8642 may provide media conversion for content such as text to speech.

Content handler 8643 may provide content abridging or selection. Such abridging or selection may depend, for example, on UI space allocation or on dynamic determination based (for example) on the content of the ticket and communication contained in it. Thus, if the ticket and its communication focus on issue A, and a KB article describes solutions related to A, B and C, content handler 8643 may abridge or remove the less-relevant parts of the KB article.

Content handler 8643 may also adapt content to a specific client situation (using rule engine 84). For example, knowledge base articles may include agent instructions (such as engagement scripts to be followed by the agent) and content handler 8643 may modify the articles based on the known agent parameters (such as skills and language proficiency).

Content handler 8643 may also adapt the knowledge base part of repository 85 itself, e.g., unpublishing or otherwise hiding KB articles which haven't been used in a long time or which received negative feedback from agents or clients.

KB article generator 8645 may create knowledge base articles (e.g., using rule engine 84 and a generative machine learning (ML) model as described in detail herein above).

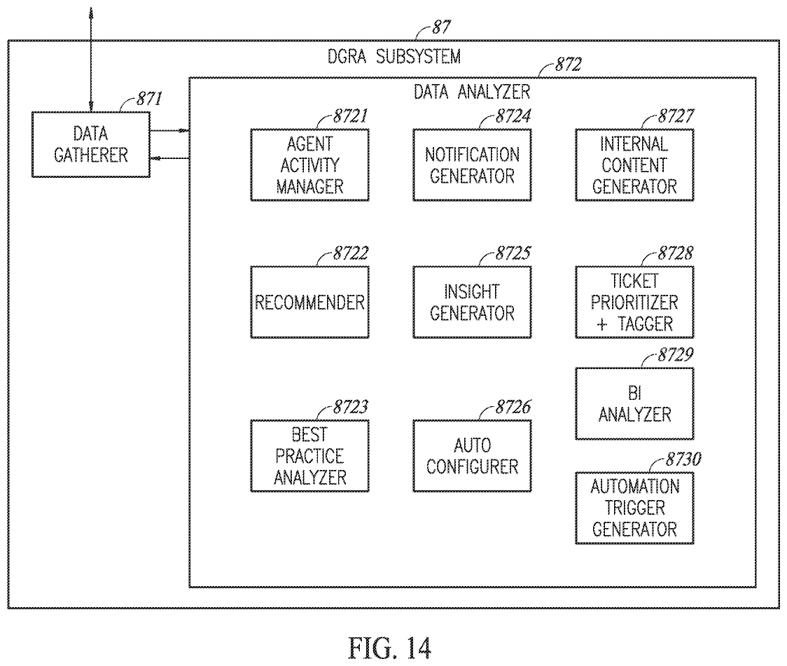

DGRA subsystem 87 may include a range of data gathering and analysis systems to support system 80. Reference is now made to FIG. 14 which illustrates the elements of DGRA subsystem 87. DGRA subsystem 87 may further comprise a data gatherer 871 and a data analyzer 872. Data analyzer 872 may further comprise an agent activity manager 8721, a recommender 8722, a best practice analyzer 8723, a notification generator 8724, an insight generator 8725, an auto configurer 8726, an internal content generator 8727, a ticket prioritizer and tagger 8728, a BI (business information) analyzer 8729 and an automation trigger generator 8730.

It will be appreciated that the elements of DGRA subsystem 87 may use AI and ML engine 841 with AI and ML models to affect system 80 behavior as described in more detail herein below. It will be further appreciated that AI/ML engine 841 may train the AI/ML models using the collected data as collected by data gatherer 871 as described herein above. It will also be appreciated that forms and other feedback provided by a client or an agent may have a higher value in the training as they directly reflect client satisfaction. DGRA subsystem 87 may further drive automation processes as discussed in more detail herein below.

Data gatherer 871 may gather and record some or all the information associated with tickets, their interaction and the activities of the agents. This may include data gathered from all system objects, reflecting activity from session initiation to closing and feedback (and post-session activities as well). Such gathering and analysis may be performed both in real-time and offline.

Data gatherer 871 may also gather derived information. Such derived information may include (for example) text recognized based on analysis of voice-based interactions or information derived from voice or video-based interactions (e.g., indicators of stress, urgency or other relevant emotions).

Data analyzer 872 may then perform higher level analysis on the data gathered by data gatherer 871 to generate results and automated actions.

Agent activity manager 8721 may analyze and rate agent activity. Agent activity manager 8721 may do this by reviewing and understanding the activities of each agent within system 80, based on gathered parameters concerning agent activity and known metrics. This information may be used for management reporting, detecting tickets which should involve additional agents, classification of tickets elements (e.g., for regulatory reporting in some industries such as financial consulting industry or medical applications) and for detection of situations requiring intervention. It will be appreciated that an agent rating may be used to drive the association of a ticket with other agents when necessary. For example, a ticket may have been delegated to an agent who is having difficulty handling the ticket by himself.

Agent activity manager 8721 may also analyze re-assignment of tickets (based on agent load, ticket-agent matching and success in handling). This may include auto routing based on additional criteria, including user defined ones.

Agent activity manager 8721 may further review any engagement and reward modules for agents. Such a module could increase an agent's engagement with system 80 and provide an incentive system for the agents. Agent activity manager 8721 may drive the merit/point awards for an agent. Agent activity manager 8721 may further analyze system performance against SLA (service Level Agreement) requirements.

Recommender 8722 may make ticket assignment recommendations for managers of agents. In particular, DGRA subsystem 87 may perform initial routing of incoming tickets based on the gathered information, and may also perform follow-up routing (e.g., when an agent needs an expert on a given subject). It will be appreciated that system 80 may be viewed as being feed orientated (rather than being routing orientated). For example, agents may watch (multiple) feeds and may request to join and handle multiple tickets.

Recommender 8722 may also suggest knowledge base articles for specific situations as well as also locate similar tickets (or specific interactions inside tickets) based on content, handled issues or other parameters. Recommender 8722 may provide links to these tickets, allowing an agent to review the progress of the linked tickets and infer on best courses of action/practice.

Recommender 8722 may also suggest specific (non-knowledge base) answers or other content and suggest specific contacts, e.g., which agents (or other people) could help the agent in a given situation.

Best practice analyzer 8723 may recognize best practices of agents and highlight them. For example, best practice analyzer 8723 may continuously analyze tickets related to similar problems, review the actions used to resolve these tickets, rate those actions and create a set of “best practices”.

The created sets of best practices may be used to create more nuanced action recommendations for agents, including multiple possible courses of action for specific situations and to create work packages for knowledge base article writers. These packages may be used later to write additional articles for KB creator and editor 86. The sets may also be used to automatically create knowledge base articles through rule engine 84.

Notification generator 8724 may generate alerts and notifications in specific situations such as alerts due to a negative interaction developing in a ticket or alerts related to cross-ticket issues and problems. For example, insight generator 8725 may detect that specific problems (such as a response time or downtime issue with supported system 100) are related and are reported over multiple channels by multiple different clients.

Insight generator 8725 may generate insights (including reporting and alerts) based on patterns or trend analysis involving wide-spectrum or long-term analysis. This could involve detecting system-wide trends, or repeating sequences of events (e.g., complaints of a specific type following earlier complaint of a different type). This could also include generating user defined reports on system metrics and analytics measures (such as calls per agent, average time to response etc.)

Auto configurer 8726 may generate system configuration changes. These may include, for example, changes to IVR scripts and configuration, or changes to load balancing parameters (based on expectations of ticket and interaction volumes).

Internal content generator 8727 may generate content for KB article generator 8645 or to complete or complement agent writings, voice, video or other communication. This could be done using AI/ML engine 841 and generative ML models (such as GPT-3) which can use any initial response text entered by an agent and complete the text. Unlike regular generative models, such models could also take into account the inputs relating to the supported clients and the issue being handled. System 80 may allow the agent to edit or reject the suggested completion text.

Ticket prioritizer and tagger 8728 may provide priority and tag information to the tickets. Such information can then be used to select and order information for inboxes (feeds). This way a feed could include (for example) all client calls related to a certain tagged issue (based on a tag resulting from analysis of the ticket's content and information) even if the issue is not directly mentioned in the ticket's text, audio or video information.

BI analyzer 8729 may also use and integrate BI events and other information from the BI sub-system of supported system 100 (such as a WBS). BI analyzer 8729 may interact with the WBS's underlying BI system to integrate WBS BI events and other information. An example is the detection of a specific WBS event (such as a configuration change, a database event or other event) which may be followed within X minutes by a given set of complaints (as represented by client calls and opened tickets).

Automation trigger generator 8730 may activate additional automation actions based on various scenarios. Automation trigger generator 8730 may raise triggers (in specific scenarios) that activate an automation engine. This automation engine, in turn, may operate different parts and functionalities of system 80, and thereby saving on manual agent/operator work and execution of repetitive actions. In an alternative embodiment, system 80 may offer an automation definition editor, allowing an agent to design his automation scripts. System 80 may also offer a repository of automation script templates (separate to or as part of repository 85), which can be used as the basis for the agent's automation scripts.

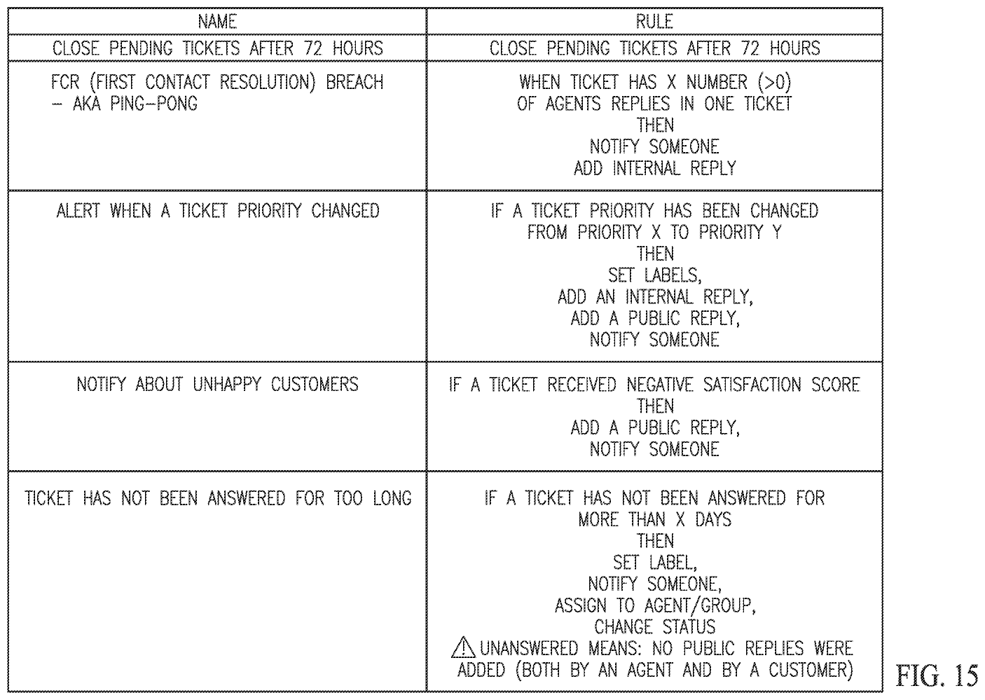

Reference is now made to FIG. 15 which shows examples of scenarios under which automation trigger generator 8730 may activate automation triggers.

The description above focuses on human agents using system 80. However, users of system 80 may include fully automated nodes (e.g., bots or other computerized elements communicating with system 80) as well as semi-automated nodes (such as a person communicating through system 80 which is assisted in his or her communication by automated means).

Bots can also participate in agent roles and be assigned to handling tickets. Bot agent operator 88 may handle all bot operations and may, for example conduct an initial dialog with a client so to perform initial diagnostics which could affect follow-up assignment of agent(s) to the ticket. Bot agent operator may further comprise an interaction assister 881.

Bot agent operator 88 may also operate a bot to guide a client through a specific procedure that requires multiple steps. In this scenario an agent may (for example) may hand over an interaction to a bot to guide the client, oversee the bot' s interaction with the client, and return to the interaction once the specific procedure has ended. It will be appreciated that the sub elements of system 80 may handle bots as they would a human agent and that bot agent operator 88 may coordinate with the other elements of system 80 to provide this functionality.

Bot agent operator 88 may also operate a bot to engage with clients when human agents are not available or are over-loaded (as determined by rule engine 84). The bot may take the role of an actual agent and interact with the client. System 80 may continue to monitor the agent workload and match the ticket with the appropriate human (based on load and suitability). The human agent can then take over the interaction (and the ticket) at this point. Bot agent operator 88 may also escalate the ticket to a human agent if the bot determines that certain actions or decisions need to be taken, which require human interaction or approval (e.g., because they have substantial effects).

Thus, bot-related parameters (e.g., bot or not, length of automated interaction) may be used as parameters for inbox/queue display selection for ticket subsystem 82 and inbox/feed subsystem 83 together with DGRA subsystem 87 as described herein above.

System 80 may also allow agents to view and join tickets handled by bots (including “silently” viewing the interaction—possibly before joining the ticket). An agent could (for example) review a segment of the bot interactions and join the interaction or take it away from the bot as required.

Interaction assister 881 may provide automated agent assistance which does not amount to complete agent replacement. Such automatic assistance may include assisted interaction (enhancing, completing, or completing the agent's interaction—written or otherwise). The assistance may also include suggesting courses of actions or relevant material or links as described for the rule engine recommendation function above.

Thus, a communication system integrated with a supported system may provide communication using channels of different interactivity which may be handled according to the interactivity. The system may generate an integrated display which tracks interactions of multiple types, allowing sorting and selecting by interactivity levels for composite tickets. The system may also generate a ticket display which includes multiple activities and interactions and allows for tracking and participation for multiple interactions of different interactivity levels.

The system may also generate an inbox display from a specific viewpoint, e.g., show what a given agent is seeing (with or without using the agents selection/sorting criteria).

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one hardware processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A communication system, the system comprising:
a processor; and
a unit running on said processor, said unit to create and handle a dynamic display of at least one ticket, said at least one ticket representing an incoming event for a supported system supported by said communication system, said at least one ticket further representing activities related to said incoming event and the status of multiple channels of interactivity between at least one client and at least one agent associated with said supported system, said unit comprising:
a ticket subsystem to receive said incoming event, said activities and said multiple channels of interactivity from at least one communication channel and to create and update said at least one ticket accordingly; and
an inbox/feed subsystem to create and display a one-inbox feed for said at least one ticket for said at least one agent.

2. The communication system according to claim 1 wherein said communication system is integrated with said supported system.

3. The communication system according to claim 1 and also comprising a channel transformer to adapt a user interface of said communication system to communicate with at least one client device belonging to said at least one agent.

4. The communication system according to claim 1 and further comprising at least one of:
a repository storing at least ticket information and parameters, agent profiles, management data and pre-defined rules;
a data gathering, recording and analysis (DGRA) subsystem to provide data gathering and analysis of gathered information for said ticket subsystem and said inbox/feed subsystem;
a knowledge base (KB) creator and editor to create and edit knowledge base content for use by said ticket subsystem;
a bot agent operator to integrate bot agents into the functionality of said at least one agent; and
a rule engine to provide rule, artificial intelligence and machine learning support to said ticket subsystem, said inbox/feed subsystem, said DGRA subsystem, said KB creator and editor and said bot agent operator.

5. The communication system according to claim 4 wherein said ticket subsystem comprises at least one of:
a ticket handler to receive said incoming event;
a ticket creator to create a ticket for said incoming event;
a ticket updater to update said ticket for said incoming event according to changing interactivity and said activities;
a remote access handler to remotely access a device of said at least one client and to interact with secondary devices connected to said device;
a remote software handler to handle communications related to at least one of software installations, upgrades and changing configurations to said device;
a ticket input form builder to gather and fill said ticket with related information;
a ticket displayer to prepare a representation of multiple parallel activities and interactions of said ticket for display; and
an association manager to handle associations between said ticket, said at least one client and said at least one agent.

6. The communication system according to claim 5 wherein said association manager comprises:
a privilege/role manager to assign rules and privileges to said at least one agent for said communication system; and
an agent set handler to handle associations of said at least one agent with said at least one ticket.

7. The communication system according to claim 4 wherein said inbox/feed subsystem comprises:
an inbox generator to generate and update a feed of at least one ticket for said at least one agent;
a feed displayer to dynamically generate a user interface (UI) element to display said feed; and
a dynamic view constructor to construct at least one view to display a list of agents registered with said communication system and their associated activity information.

8. The communication system according to claim 7 wherein said inbox generator comprises:
a feed constructor to construct said feed;
a feed updater to update said feed according to activity information and requirements of said at least one agent;
a feed manager to manage multiple feeds;
a query receiver and executor to instruct said feed constructor according to results of a query placed by said at least one agent; and
an information deriver to instruct said feed constructor according to information derived from said at least one ticket.

9. The communication system according to claim 4 wherein said DGRA subsystem comprises at least one of:
a data gatherer to gather and record information associated with tickets, their interactions and the activities of said at least one agent; and
a data analyzer to analyze said information and to generate automated actions accordingly for said ticket subsystem and said inbox/feed subsystem.

10. The communication system of claim 9 wherein said data analyzer comprises at least one of:
an agent activity manage to analyze and rate agent activity of said at least one agent;
a recommender to make ticket assignment recommendations for managers of said at least one agent;
a best practice analyzer to recognize and highlight best practices for said at least one agent;
an insight generator to generate insights according to patterns or trend analysis for said information;
a notification generator to generate alerts and notifications for pre-defined situations;
an auto configurer to generate configuration changes for said communication system;
an internal content generator to generate content for said KB creator and editor;
a ticket prioritizer and tagger to provide priority and tag information for said at least one ticket;
a BI (business information) analyzer to integrate business information from said supported system; and
an automation trigger generator to activate automation actions according to pre-defined rules.

11. The communication system of claim 4 wherein said KB creator and editor comprises at least one of:
a KB editor to provide authoring and design tools for the creation of embedded training material and courseware for said at least one agent and said at least one client;
a KB collection creator to create a collection of knowledge base articles for use by users of said supported system;
a KB widget creator to create a widget embedded in a website to present knowledge base articles; and
a KB processing engine to automatically select, recommend, create, modify or adapt knowledge-based content according to said gathered information.

12. The communication system according to claim 1 wherein said at least one ticket comprises at least one of: the status of interactions between said at least one agent and said at least one client, opening events, closing events, display forms and questionnaires, notes of said at least one agent, ticket meta data, links to related tickets, knowledge base content, ticket association information.

13. The communication system according to claim 1 wherein said at least one communication channel is at least one of: a social network, email, a shared virtual space, a web service, an organized communication system, an online forum, an online chat room and a messaging system.

14. The communication system of claim 7 wherein said feed displayer creates a combined user interface showing different levels of said multiple channels of interactivity for said incoming event.

15. The communication system of claim 5 wherein said ticket displayer displays a single ticket display representing said activities and said multiple channels of interactivity.

16. The communication system of claim 15 wherein said ticket displayer displays a summarized version of said multiple channels of interactivity according to an analysis of stored communication data by said rule engine.

17. A method, the method comprising:
creating and handling a dynamic display of at least one ticket, said at least one ticket representing an incoming event for a supported system supported by a communication system, said at least one ticket further representing activities related to said incoming event and the status of multiple channels of interactivity between at least one client and at least one agent associated with said supported system, creating and handling a dynamic display comprising:
receiving said incoming event, said activities and said multiple channels of interactivity from at least one communication channel and creating and updating said at least one ticket accordingly; and
creating and displaying a one-inbox feed for said at least one ticket for said at least one agent.

18. The method according to claim 17 wherein said communication system is integrated with said supported system.

19. The method according to claim 17 and also comprising adapting a user interface of said communication system to communicate with at least one client device belonging to said at least one agent.

20. The method according to claim 17 and further comprising at least one of:
storing in a repository at least ticket information and parameters, agent profiles, management data and pre-defined rules;
providing data gathering and analysis of gathered information for said creating and updating said at least one ticket and said creating and displaying a one-inbox feed;
creating and editing knowledge base content for use by said creating and updating said at least one ticket;
integrating bot agents into the functionality of said at least one agent; and
providing rule, artificial intelligence and machine learning support for said creating and updating said at least one ticket, said creating and displaying a one-inbox feed, providing data gathering and analysis. said creating and editing knowledge base content and said integrating bot agents.

21. The method according to claim 20 wherein said creating and updating said at least one ticket comprises at least one of:
receiving said incoming event;
creating a ticket for said incoming event;
updating said ticket for said incoming event according to changing interactivity and said activities;
remotely accessing a device of said at least one client and to interact with secondary devices connected to said device;
handling communications related to at least one of software installations, upgrades and changing configurations to said device;
gathering and filling said ticket with related information;
preparing a representation of multiple parallel activities and interactions of said ticket for display; and
handling associations between said ticket, said at least one client and said at least one agent.

22. The method according to claim 21 wherein said handling associations comprises:
assigning rules and privileges to said at least one agent for said communication system; and
handling associations of said at least one agent with said at least one ticket.

23. The method according to claim 20 wherein said creating and displaying a one-inbox feed comprises:
generating and updating a feed of at least one ticket for said at least one agent;
dynamically generating a user interface (UI) element to display said feed; and
constructing at least one view to display a list of agents registered with said communication system and their associated activity information.

24. The method according to claim 23 wherein said generating and updating a feed comprises:
constructing said feed;
updating said feed according to activity information and requirements of said at least one agent;
managing multiple feeds;
instructing said constructing said feed according to results of a query placed by said at least one agent; and
instructing said constructing said feed according to information derived from said at least one ticket.

25. The method according to claim 20 wherein said providing data gathering and analysis comprises at least one of:
gathering and recording information associated with tickets, their interactions and the activities of said at least one agent; and
analyzing said information and generating automated actions accordingly for said ticket subsystem and said inbox/feed subsystem.

26. The method of claim 25 wherein said analyzing said information and generating automated actions comprises at least one of:
analyzing and rating agent activity of said at least one agent;
making ticket assignment recommendations for managers of said at least one agent;
recognizing and highlighting best practices for said at least one agent;
generating insights according to patterns or trend analysis for said information;
generating alerts and notifications for pre-defined situations;
generating configuration changes for said communication system;
generating content for said KB creator and editor;
providing priority and tag information for said at least one ticket;
integrating business information from said supported system; and
activating automation actions according to pre-defined rules.

27. The method of claim 20 wherein said creating and editing knowledge base content comprises at least one of:
providing authoring and design tools for the creation of embedded training material and courseware for said at least one agent and said at least one client;
creating a collection of knowledge base articles for use by users of said supported system;
creating a widget embedded in a website to present knowledge base articles; and
automatically selecting, recommending, creating, modifying or adapting knowledge-based content according to said gathered information.

28. The method according to claim 17 wherein said at least one ticket comprises at least one of: the status of interactions between said at least one agent and said at least one client, opening events, closing events, display forms and questionnaires, notes of said at least one agent, ticket meta data, links to related tickets, knowledge base content, ticket association information.

29. The method according to claim 17 wherein said at least one communication channel is at least one of: a social network, email, a shared virtual space, a web service, an organized communication system, an online forum, an online chat room and a messaging system.

30. The method of claim 23 wherein said dynamically generating a user interface (UI) element creates a combined user interface showing different levels of said multiple channels of interactivity for said incoming event.

31. The method of claim 21 wherein said preparing a representation displays a single ticket display representing said activities and said multiple channels of interactivity.

32. The method of claim 31 wherein said preparing a representation displays a summarized version of said multiple channels of interactivity according to an analysis of stored communication data by said providing rule, artificial intelligence and machine learning support.
